(19) United States
(12) Patent Application Publication
(10) Pub. No.: US 2008/0247652 A1
(43) Pub. Date: Oct. 9, 2008

(54) Q-METRIC BASED SUPPORT VECTOR MACHINE

(75) Inventors: Magdi A. Mohamed, Schaumburg, IL (US); Weimin Xiao, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/696,505

(22) Filed: Apr. 4, 2007

(51) Int. Cl. G06K 9/62; G06K 9/46; G06K 9/66

(52) U.S. Cl. 382/224; 382/190; 382/155

(57) ABSTRACT

A Support Vector Machine (110) with a Q-Metric kernel function computer (112) is provided. The Support Vector Machine (110) exhibits improved performance for classification and regression. Pattern recognition systems (100,900) that use the Support Vector Machine (110) are also provided. A Differential Evolution method of training a Support Vector Machine is also provided.

### FIELD OF THE INVENTION

The present invention relates generally to pattern recognition systems.

### BACKGROUND

There are numerous types of practical pattern recognition systems including, by way of example, facial recognition, and fingerprint recognition systems which are useful for security, speech recognition and handwriting recognition systems which provide alternatives to keyboard based human-machine interfacing, radar target recognition systems and vector quantization systems which are useful for digital compression and digital communications.

Generally, pattern recognition works by using sensors to collect data (e.g., image, audio) and using an application specific feature vector extraction process to produce one or more feature vectors that characterize the collected data. The nature of the feature extraction process varies depending on the nature of the data. Once the feature vectors have been extracted, a particular classification sub-system is used to determine a vector subspace in which the extracted feature vector belongs. Each vector subspace corresponds to one possible identity of what was measured using sensors. For example in facial recognition, each vector subspace can correspond to a particular person. In handwriting recognition each vector subspace can correspond to a particular letter or writing stroke and in speech recognition each subspace can correspond to a particular phoneme-an atom of human speech.

One type of pattern recognition algorithm that is used to map feature vectors to a particular vector sub-space is called Support Vector Machine (SVM). Support Vector Machines are based on a formulation of the task of finding decision boundaries as an inequality constrained optimization problem. The goal of Support Vector Machines is to find decision boundary for which the distance (margin) between the decision boundary and exemplars of classes on both sides of the boundary is maximized. The earliest SVM algorithms were aimed at finding a linear boundary defined by a vector w and a bias wₒ in a feature vector space. More recently the so-called ‘Kernel trick’ which replaces vector dot products used in the SVM with non-linear functions have been proposed. Examples of Kernel functions K(X,Y) that have been used in Support Vector Machines include Linear K(X,Y)=X^{T}Y, Polynomial K(X,Y)=(γX^{T}Y+δ)^{d}, Radial Basis Function K(X,Y)=exp(−γ∥X−Y∥²), and Sigmoid K(X,Y)=tanh(γX^{T}Y+δ), where γ, δ, and d are fixed parameters for their corresponding kernels. However, these kernel functions are typically used with fixed values of configurations parameters (e.g., P=2 and a fixed value of γ in the case of the Radial Basis Function) so that a simplified Quadratic Programming method can be used to determine the unknown Support Vectors characterizing the input data.

A new distance metric function called the Q-Metric which is useful in pattern recognition is disclosed in Co-pending patent application Ser. No. 11/554,643 filed Oct. 31, 2006, entitled “System For Pattern Recognition With Q-Metrics” by Magdi Mohamed et al. One mathematical expression of the Q-Metric is given by:

$${d}_{λ} ( x , y ) = \{ \begin{matrix}\frac{{\prod }_{i = 1}^{n} ( 1 + λ \vert {x}_{i} - {y}_{i} \vert ) - 1}{λ} & λ ∈ [ - 1 , 0 ) \\ {\sum }_{i = 1}^{n} \vert {x}_{i} - {y}_{i} \vert & λ = 0\end{matrix} \qquad EQU . 1$$

where,
λ ε [−1,0] is a configuration parameter;
xᵢ ε [0,1] is an i^{th} component of a first n-dimensional feature vector denoted X
yᵢ ε [0,1] is an i^{th} component of a second n-dimensional feature vector denoted Y;
d_{λ} (x,y) ε [0,n] is a distance between the first feature vector and the second feature vector, computed by the Q-Metric.

For computationally intensive pattern recognition applications, such as training with large, high dimensional training data sets, and on-line recognition at high data rates, the Q-Metric offers the advantage that it only involves elementary arithmetic operations, e.g., addition, subtraction, multiplication, and division. This is unlike the Sigmoid and Gaussian functions mentioned above and unlike the P-Metric;

$${d}_{p} ( x , y ) = \sqrt[p]{{\sum }_{i = 1}^{n} \vert {x}_{i} - {y}_{i} {\vert}^{p}} \qquad EQU . 2$$

where, xᵢ and yᵢ are i^{th} coordinates of a first and second vector respectively. The P-Metric involves raising to the power p (which may range up to a high value) and taking a p^{th} root. Since p may take on arbitrary values within a specified range, evaluating the P-Metric, especially the root is computationally intensive and could be numerically unstable. This is in contrast to the Q-Metric, which as stated involves elementary operations. However, like the P-Metric, the Q-Metric is configurable through a range of function from a setting with λ=0 approximating the Manhattan (Taxi Cab) distance to a configuration with λ=−1 approximating the p metric with p=infinity. Thus, the Q-Metric has advantages in terms of metric property versatility yet has a low computational cost.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a pattern recognition system according to an embodiment of the invention;

FIG. 2 is a block diagram of a Q-Metric computer according to an embodiment of the invention;

FIG. 3 is a block diagram of Q-Metric computer according to an alternative embodiment of the invention;

FIG. 4 is a graph showing unity Q-Metric distance contour plots for three values of the configuration parameter λ;

FIG. 5 is flowchart of a training programming for a Q-Metric based Support Vector Machine that uses Differential Evolution;

FIG. 6 is a flowchart of a method of using the SVM trained by process shown in FIG. 5;

FIG. 7 is a graph showing the result produced by a prior art classification Support Vector Machine;

FIG. 8 is a graph showing the result produced by a Q-Metric classification Support Vector Machine;

FIG. 9 is a Q-Metric Support Vector Machine regression system.

FIG. 10 is a graph showing the result produced by a prior art regression Support Vector Machine;

FIG. 11 is a graph showing the result produced by a Q-Metric regression Support Vector Machine; and

FIG. 12 is a block diagram of a computer on which a software implemented Support Vector Machine can be run.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to Support Vector Machines. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of Support Vector Machines described herein. The non-processor circuits may include, but are not limited to, signal drivers, clock circuits, power source circuits, and user input devices. As such, these functions may be interpreted as steps of a method to perform pattern recognition (classification and regression tasks). Alternatively, some or all functions could be implemented by a state machine that has no stored program instructions, or in one or more Application Specific Integrated Circuits (ASICs) or Field Programmable Gate Arrays (FPGAs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and Integrated Circuits (ICs) with minimal experimentation.

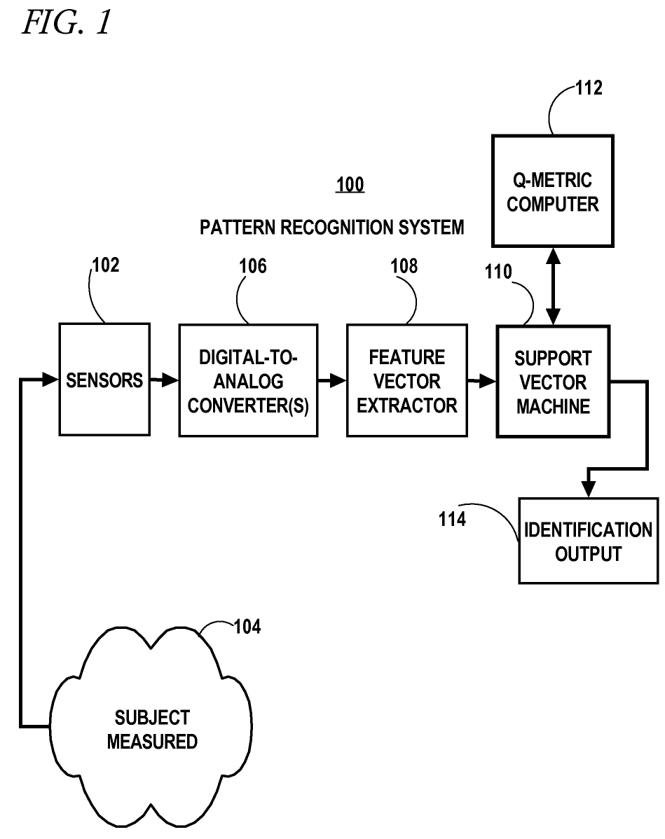

FIG. 1 is a block diagram of a pattern recognition system 100. The pattern recognition system 100 has one or more sensors 102 that are used to collect measurements from subjects to be recognized 104. By way of example, subjects 104 can be living organisms such as persons, spoken words, handwritten words, animate or inanimate objects. The sensors 102 can take different forms depending on the subject. By way of example, various types of fingerprint sensors can be used to sense finger prints, microphones can be used to sense spoken words, cameras can be used to image faces, touch screens can be used to read hand written words and radar can be used to sense airplanes and other objects.

The sensors 102 are coupled to one or more digital-to-analog converters (D/A) 106. The D/A 106 is used to digitize the data collected by the sensors 102. Multiple D/A's 106 or multi-channel D/A's 106 may be used if multiple sensors 102 are used. By way of example, the output of the D/A 106 can take the form of time series data and images. The D/A 106 is coupled to a feature vector extractor 108. The feature vector extractor 108 performs lossy compression on the digitized data output by the D/A 106 to produce a feature vector which compactly represents information derived from the subject 104. Various feature vector extraction programs that are specific to particular types of subjects are known to persons having ordinary skill in the relevant arts.

The feature vector extractor 108 is coupled a Support Vector Machine 110. Assigning a feature vector to a sub-space completes a task of classifying the subject. The SVM 110 is coupled to a Q-Metric computer 112. The Q-Metric computer 112 is used to compute Q-Metric distances that are used as Kernel function values by the SVM 110. The Q-Metric computer 112 may be implemented in software, hardware or a combination of hardware and software.

An identification output 114 is coupled to the SVM 110. Information identifying a particular vector-subspace (which corresponds to a particular class or individual) is output via the output 114. The identification output 114 can, for example, comprise a computer monitor.

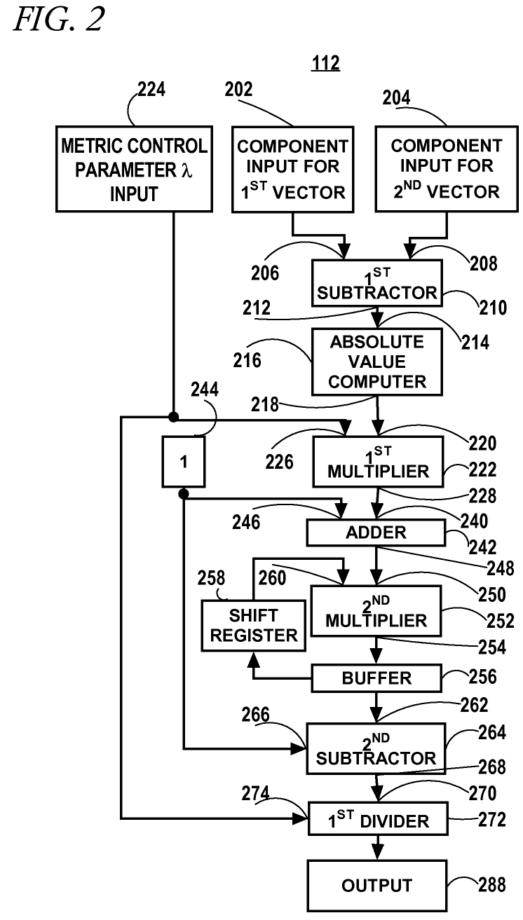

FIG. 2 is a detailed block diagram of the Q-Metric computer 112 according to an embodiment of the invention. A first feature vector component input 202 and a second (exemplar) feature vector component input 204 are coupled to a first input 206 and a second input 208, respectively, of a first subtracter 210. The first feature vector component input 202 and the second feature vector component inputs 204 receive vector components sequentially. In response to each pair of feature vector components, the first subtracter 210 produces a difference at a first subtracter output 212. The first subtracter output 212 is coupled to an input 214 of an absolute value computer 216. An output 218 of the absolute value computer 216 is coupled to a first input 220 of a first multiplier 222. A metric control parameter input 224 of the Q-Metric computer 112 is coupled to a second input 226 of the first multiplier 222. The first multiplier 222 sequentially receives absolute values of component differences computed by the absolute value computer 216. An output 228 of the first multiplier 222 is coupled to a first input 240 of an adder 242. A fixed value 244 (e.g., unity) is coupled to a second input 246 of the adder 242. An output 248 of the adder 242 is coupled to a first input 250 of a second multiplier 252. An output 254 of the second multiplier 252 is coupled to a buffer 256 which is coupled through a shift register 258 to a second input 260 of the second multiplier 252. An output of the shift register 258 is initialized to one. Thus, the second multiplier 252 operates recursively. When all the feature vector components have been fed into configurable feature vector distance computer 200 a final product will be stored in the buffer 256. The buffer 256 is coupled to a first input 262 of a second subtracter 264. The fixed value 244 (e.g., unity) is coupled to a second input 266 of the second subtracter 264. The second subtracter 264 subtracts the fixed value 244 from the product received from the buffer 256. An output 268 of the second subtracter 264 is coupled to a numerator input 270 of a divider 272. The input for the metric control parameter 224 is coupled to a denominator input 274 of the divider 272. The divider 272 divides the value obtained at the first input 270 by the metric control parameter received from the input 224. An output 276 of the divider 272 is coupled an output 288 of the configurable feature vector distance computer 200.

Another way to compute the Q-Metric distance given by EQU. 1 is by evaluating the following recursion relation.

Ψᵢ=Ψᵢ₋₁+|xᵢ−yᵢ|+λΨᵢ₋₁|xᵢ−yᵢ| EQU. 2

starting with an initial function value:

Ψ₀=0

up to subscript N where N is the dimensionality of the feature vectors. The Q-Metric distance metric given by EQU. 1 is also determined by

d_{λ}(x,y)=Ψ_{N}

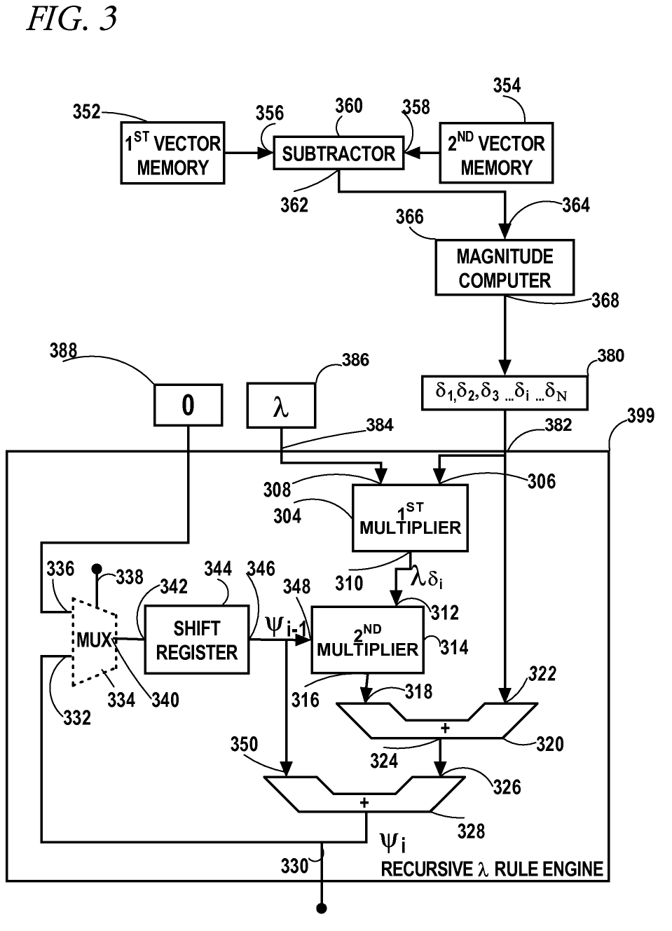

FIG. 3 is a block diagram of an implementation of the Q-Metric computer 112 that uses efficient recursive computation based on EQU. 3. Referring to FIG. 3, a first vector memory 352 and a second vector memory 354 are coupled to a first input 356 and a second input 358 of a subtracter 360. An output 362 of the subtracter 360 is coupled to an input 364 of a magnitude computer 366. The subtracter 360 computes a vector difference between the first vector 352 and the second vector 354 and outputs a set of component differences. The magnitude computer 366 computes the absolute value of each component difference. A first multiplier 304 of a recursive λ-rule engine 399 receives the absolute values of the successive component differences 380 at a first input 306. The absolute values of the differences are received through a first input 382 of the λ-rule engine 399. The lambda rule engine 399 is described in co-pending patent application Ser. No. 11/554,704 filed Oct. 31, 2006 entitled “Hardware Arithmetic Engine For Lambda Rule Computations” by Irfan Nasir et al.

The first multiplier 304 receives the metric control parameter λ at a second input 308. The metric control parameter λ is received through a second input 384 of the recursive lambda rule engine 399 from a parameter register 386. The first multiplier 304 outputs a series of products λδᵢ at an output 310.

The output 310 of the first multiplier 304 is coupled to a first input 312 of a second multiplier 314. The first multiplier 304 in combination with the second multiplier 314 form a three input multiplier. One skilled in the art will appreciate that signals input to the first multiplier 304 and the second multiplier 314 may be permuted among the inputs of the first multiplier 304 and second multiplier 314 without changing the functioning of the engine 399. An output 316 of the second multiplier 314 is coupled to a first input 318 of a first adder 320. A second input 322 of the first adder 320 sequentially receives absolute values of the differences δᵢ directly from the first input 382 of the lambda rule engine 399. An output 324 of the first adder 320 is coupled to a first input 326 of a second adder 328. Accordingly, the first adder 320 and the second adder 328 form a three input adder.

An output 330 of the second adder 328 is coupled to a first input 332 of a multiplexer 334. A second input 336 of the multiplexer 334 is coupled to an initial value register 388. A control input 338 of the multiplexer 334 (controlled by a supervisory controller not shown) determines which of the first input 332 and second input 336 is coupled to an output 340 of the multiplexer 334. Initially the second input 336 which is coupled to the initial value register 388 is coupled to the output 340. For subsequent cycles of operation of the recursive lambda rule engine 399 the first input 332 of the multiplexer 334 which is coupled to the output 330 of the second adder 328, is coupled to the output of the multiplexer 334 so that the engine 399 operates in a recursive manner.

The output 340 of the multiplexer 334 is coupled to an input 342 of a shift register 344. An output 346 of the shift register 344 is coupled to a second input 348 of the second multiplier 314 and to a second input 350 of the second adder 328.

During each cycle of operation, the output of the first multiplier 304 is λδᵢ, the output of the second multiplier 314 is λδᵢψᵢ₋₁ (the third term in equation two), the output of the first adder 320 is δᵢ+λ_{D}δᵢ ψᵢ₋₁, and the output of the second adder 328 is ψᵢ₋₁+δᵢ+λ_{D}δᵢ ψᵢ₋₁, which is the right hand side of equation two. After N cycles of operation the output of the second adder 328 will be the Q-Metric distance.

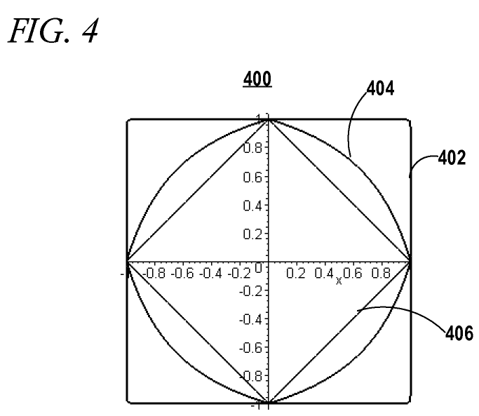

FIG. 4 is a graph 400 showing unity Q-Metric distance contour plots 402, 404, 406 for three values of the configuration parameter λ. Each of the contour plots shows a locus of Cartesian coordinates for which the Q-Metric distance from the origin is equal to one. The outer square shaped plot 402 is for the case that the configuration parameter λ is equal to −1.0. The inner diamond shaped plot 406 is for the case that the configuration parameter λ is equal to zero. The intermediate, approximately circular shaped plot 404 is for the case that the configuration parameter λ is equal to −0.7. By varying the configuration parameter other shapes between the square shaped output plot 402 and the inner diamond shaped plot 406 are obtained. Thus, by using the Q-Metric a system that is more agile in terms of adapting to the topology of the decision boundary between classifications is obtained.

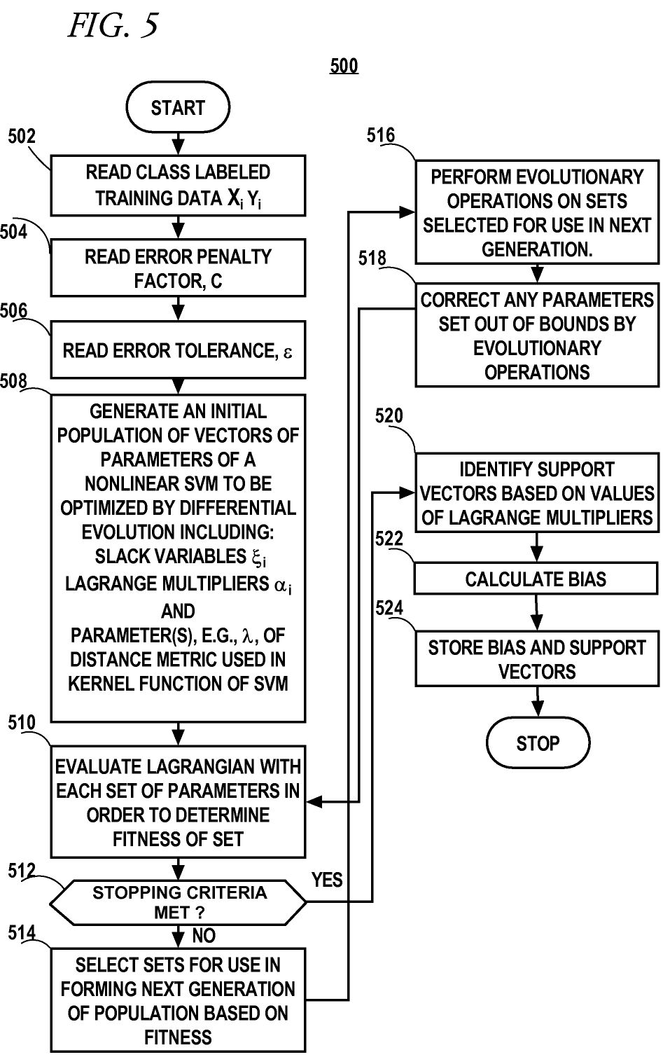

FIG. 5 is a flowchart of a training program 500 for a Q-Metric based Support Vector Machine that uses a Differential Evolution procedure. In block 502 class labeled training data is read in. The training data includes feature vectors X_{I} from two or more classifications that are to be distinguished and corresponding numerical labels Y_{I}. The labels Y_{I}, are set to +1 for one class and −1 for a second class or for a group of several other classes (or vice versa). In block 504 a predetermine penalty factor C is read and in block 506 an error tolerance ε is read.

In block 508 an initial population of vectors of numerical parameters of a non-linear SVM are generated. Each vector includes slack variables ξ_{I}, Lagrange multipliers α_{I}, and the configuration parameter λ. The values of the numerical parameters in the vectors in the initial population may be random numbers within predetermined bounds. Each vector includes a total of 2m+1 numerical parameters, where m is the number of the feature vectors read in block 502.

In block 510 an objective function to be optimized is evaluated with each vector in a current population (which initially is the initial population) The objective function is a dual form Lagrangian for a classification SVM and can, for example take the form:

$${L}_{D} = {\sum }_{i = 1}^{m} ( {α}_{i} ( 1 - {ξ}_{i} ) - C {ξ}_{i} ) - \frac{1}{2} {\sum }_{i = 1}^{m} {\sum }_{j = 1}^{m} {α}_{i} {α}_{j} {y}_{i} {y}_{j} K ( λ , {x}_{i} , {x}_{j} ) \qquad EQU . 3$$

where m is the number of training data points.

The value of the dual form Lagrangian serves as a measure of fitness of each vector for the purpose of Differential Evolution.

Next block 512 tests if a stopping criteria has been met. The stopping criteria can include a variety of tests including but not limited to: a comparison of a maximum fitness or a population average to a predetermined goal, a comparison of a current generations maximum or population average fitness to a best maximum or population average fitness among preceding generations (e.g., stop when fitness degradation or no substantial improvement is detected). Other fitness tests are known to persons of ordinary skill in the art of Differential Evolution.

If it is determined in block 512 that the stopping criteria has not yet been met, then in block 514 population members, i.e., vectors, are selected to be used in forming a next generation based on fitness. For example the stochastic remainder method may be used. Typically high fitness population members may be selected multiple time in order to maintain a constant population size.

In block 516 Differential Evolution evolutionary operations are performed on the vectors that have been selected in block 514. Such operations include one-point crossover, two-point crossover, Differential Evolution mutation and circular shifting. These operations are selectively applied using pre-programmed rates or adaptive rates that may be changed during the optimization process. For each population member and for each operation a random number (e.g., between 0 and 1) is generated and compared to a preprogrammed rate (e.g., 0.11) if the random number is less than the given rate, the operation is performed on the population member.

The numerical parameters ξ_{I} α_{I} λ are supposed to be restricted to certain bounds, i.e.:

0≧λ≧−1

C≧αᵢ≧0

ξᵢ≧0

The Differential Evolution operations that are performed in block 516 may cause certain parameter values to go out of bounds. In block 518 the values of any parameters that have been set of out of bounds are corrected. For example, if the new value of λ is larger than 0, λ can be corrected by using a negative but small random value in the permissible range. If the new value of λ is less than −1, λ can be corrected by using a random value slightly greater than −1 also in the permissible range. The constraints for the other variables can be imposed in a similar manner. Following block 518 the training program 500 returns to 510 to evaluate a new generation which has been generated in blocks 514, 516 and 518.

If in block 512 it is determined that the stopping criteria has been met, the training program 500 branches to block 520 in which support vectors are identified. Support Vectors are those training vectors xᵢ for which the corresponding Lagrange multipliers αᵢ are non-zero, or practically speaking, to accommodate the imprecision of numerical calculation those training vectors for which the corresponding Lagrange multipliers αᵢ are larger than the pre-error tolerance ε.

In block 522 a decision function bias denoted b is computed by evaluating the following function:

$$\begin{matrix}b = \frac{1}{M} {\sum }_{ɛ \leq {α}_{i} \leq C - ɛ} ( {y}_{i} - {\sum }_{ɛ \leq {α}_{j} \leq C - ɛ} {α}_{j} {y}_{j} K ( λ , {x}_{i} , {x}_{j} ) ) \\ where , & EQU . 4 \\ K ( λ , {x}_{i} , {x}_{j} ) = {e}^{- {d}_{λ} ( {x}_{i} , {x}_{j} )} & EQU . 5\end{matrix}$$

M is the number of Support Vectors (e.g. αᵢ≠0) and K(λ,xᵢ,xⱼ) is a Q-Metric based kernel function of the X_{I} and X_{J} vectors, with a value of the Q-Metric configuration parameter λ determined by Differential Evolution procedure or any other optimization method.

In block 524 the bias and the support vectors are stored for use in on-line pattern recognition.

Alternatively rather than using all of the training data in one run through the training program 500, subsets of the training data can be run through the training program successively. After each run with a subset only the support vectors are retained for use in successive runs. This approach can avoid having to solve a high dimensional non-linear optimization problem in one Differential Evolution run.

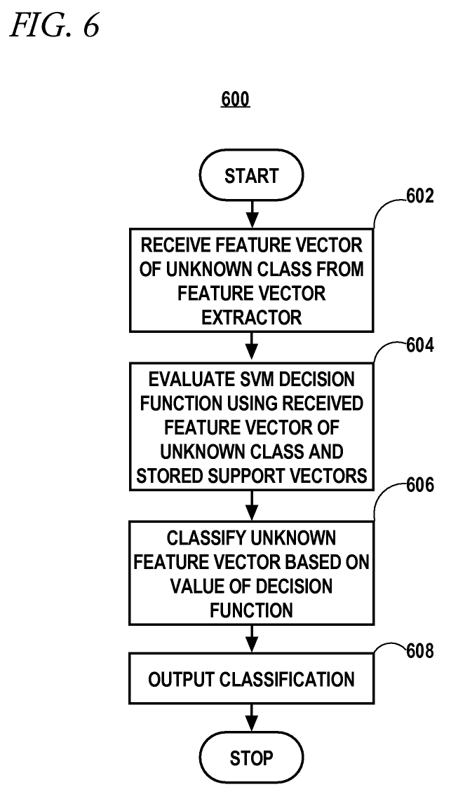

FIG. 6 is a flowchart of a method of using the SVM trained by process shown in FIG. 5. In block 602 a feature vector of unknown pattern classification is received from the feature vector extractor 108. In block 604 a SVM discriminant function is evaluating using the received feature vector and the support vectors and bias that were stored in block 524 of the training program shown in FIG. 5. One suitable discriminant function is:

The discriminant function corresponding to the separating hyperplane is given by

$$D ( x ) = {\sum }_{{α}_{i} \geq ɛ} {α}_{i} K ( λ , {x}_{i} , x ) + b \qquad EQU . 6$$

The received feature vector x is classified based on whether the discriminant function D(x) is positive or negative.

According to alternative embodiments of the invention SVM kernel functions that include the Q-Metric composed with another function are used. For example:

K(λ,xᵢ,xⱼ)=e^{-d}^{_{λ}}^{²}^{(x}^{ᵢ}^{,x}^{ⱼ}⁾ EQU. 7

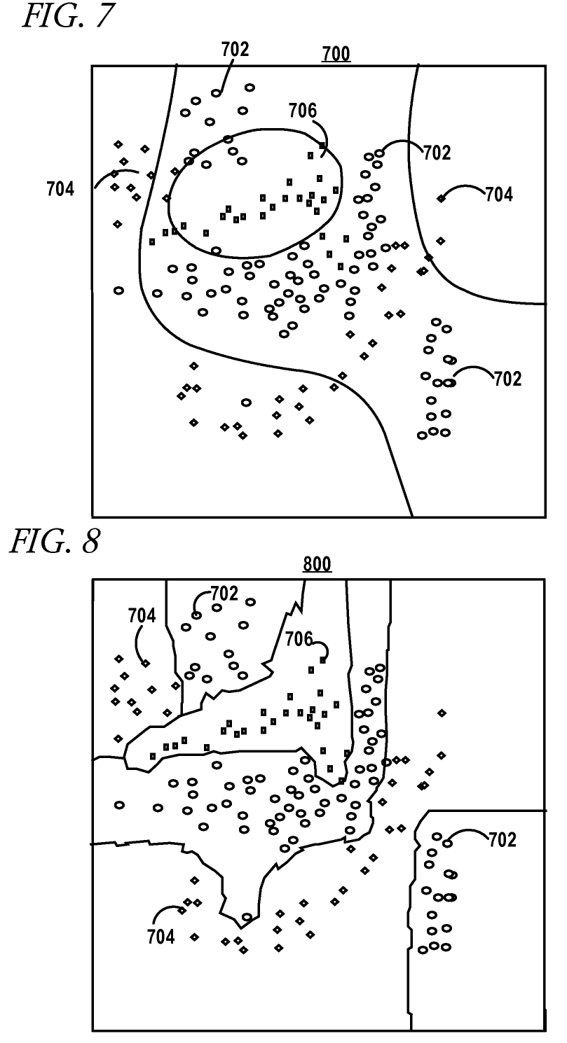

FIG. 7 is a graph 700 showing the result produced by a prior art classification Support Vector Machine and FIG. 8 is a graph 800 showing the result produced by a Q-Metric based classification Support Vector Machine. In FIGS. 7-8 a first group of 2-dimensional feature vectors 702 is indicated with oval symbols, a second group of feature vectors 704 is indicated with diamond point symbols and a third group of feature vectors 706 is represented with square point symbols. The same training data was used to produce both FIG. 7 and FIG. 8. Also in both cases a one-against-all training strategy was used to find boundaries between the three classes, i.e., by constructing one classifier for each class, which takes the given class label as a positive cases and other classes as negative cases, then classifies a data sample with the label from the classifier with the highest output. In the case of FIG. 7 a Radial Basis Function Kernel was used, the error tolerance parameter ε was initialized to 0.1, and the error penalty factor C was set to 100. As is evident in FIG. 7 entire regions of training vector points were misclassified.

On the other hand, in the case shown in FIG. 8 a Q-Metric kernel function was used and the training vectors were well classified. In the case of the SVM that produced the results shown in FIG. 8 the error tolerance parameter ε was initialized to 0.1, and the error penalty factor C was set to 100 and the Q-Metric configuration parameter λ was set to −0.5.

The training program 500 shown in FIG. 5 can also be adapted to train a SVM used for regression. A dual form Lagrangian for a regression SVM is used. An example is:

$${L}_{D} = - \frac{1}{2} {\sum }_{i = 1}^{m} {\sum }_{j = 1}^{m} ( {α}_{i} - {\overline{α}}_{i} ) ( {α}_{j} - {\overline{α}}_{j} ) K ( λ , {x}_{i} , {x}_{j} ) - ɛ {\sum }_{i = 1}^{m} ( {α}_{i} - {\overline{α}}_{i} ) + {\sum }_{i = 1}^{m} {y}_{i} ( {α}_{i} - {\overline{α}}_{i} ) - {( {\sum }_{i = 1}^{m} ( {α}_{i} - {\overline{α}}_{i} ) )}^{2} \qquad EQU . 8$$

where,
ε is a preprogrammed allowable margin;
α̅ᵢ,αᵢ are Lagrange multipliers
xᵢ are independent variable vectors
yᵢ are corresponding dependent variable values
m is the number of training data points.

For the Q-Metric SVM regression the discriminant function bias is given by:

$$b = \frac{1}{M} ( {\sum }_{0 < {\overline{α}}_{i} < C} ( {y}_{i} - ɛ - {\sum }_{j = 1}^{m} ( {α}_{j} - {\overline{α}}_{j} ) K ( λ , {x}_{j} , {x}_{i} ) ) + {\sum }_{0 < {α}_{i} < C} ( {y}_{i} + ɛ - {\sum }_{j = 1}^{m} ( {α}_{j} - {\overline{α}}_{j} ) K ( λ , {x}_{j} , {x}_{i} ) ) ) \qquad EQU . 9$$

and the regression function is given by:

$$y ( x ) = {\sum }_{{ξ \leq {\overline{α}}_{j} \leq C - ξ}_{ξ \leq {α}_{j} \leq C - ξ}} ( {α}_{j} - {\overline{α}}_{j} ) K ( λ , {x}_{j} , x ) + b \qquad EQU . 10$$

where, ξ is a pre-programmed small number-effectively a tolerance on zero for numerical computation. The Support Vectors for the regression task are those training vectors xⱼ for which the corresponding Lagrange multipliers αⱼ or α̅ⱼ are non-zero, or practically speaking, to accommodate the imprecision of numerical calculation those training vectors for which the corresponding Lagrange multipliers αⱼ or α̅ⱼ are larger than the pre-error tolerance ξ.

A modified form of the training program 500 shown in FIG. 5 can be used to train a Q-Metric SVM for regression. In the modified form, the training data that is read in in block 502 includes dependent variable values yᵢ and each vector in the population of vectors that is being evolved includes the Lagrange multipliers α̅ᵢ,αᵢ and the Q-Metric configuration parameter λ.

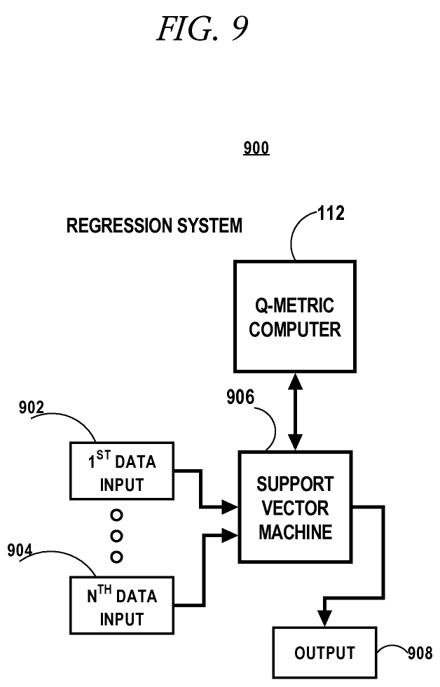

FIG. 9 is a Q-Metric Support Vector Machine regression system 900. As shown in FIG. 9, the system 900 includes a first data input 902 through an N^{TH} data input 904 coupled to a regression support vector machine 906. The Q-Metric computer 112 is also coupled to the support vector machine 906. The Q-Metric computer 112 computes Q-Metric distances between an input data vector (received via inputs 902 to 904) and stored support vectors and supplies the computed Q-Metric distances to the regression Support Vector Machine 906. The regression Support Vector Machine supplies an output value through an output 908. The inputs 902 through 904 can receive data from other systems (not shown) including sensors or from stored data. The output 908 can be coupled to other systems such as servos of a control system or computer memory, or a display screen.

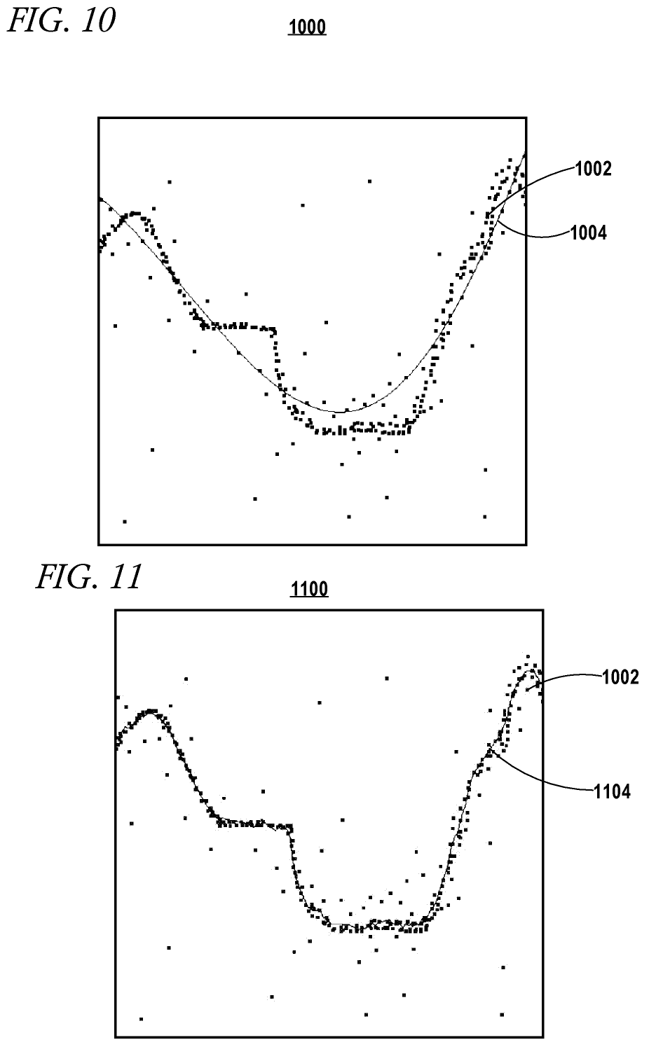

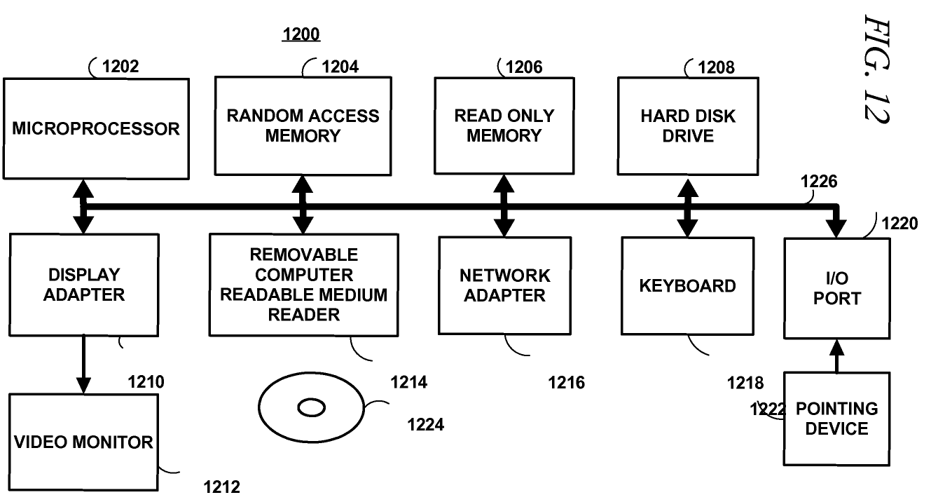

FIG. 10 is a graph 1000 showing the result produced by a prior art regression Support Vector Machine and FIG. 11 is a graph 1100 showing the result produced by a Q-Metric regression Support Vector Machine. Both graphs 1000, 1100 show a set of measured (x,y) data 1002 and a regression curve—1004 in the case of FIG. 10 and 1104 in the case of FIG. 11. The result shown in FIG. 10 was obtained using a Radial Basis Function Kernel, in particular:

K(x,y)=e^{-γ∥x-y∥}^{²} EQU. 11

with an initialized allowable margin ε of 0.1 and a fixed value of the parameter γ=1.0.

The result shown in FIG. 11 was obtained using a Q-Metric kernel function with the Q-Metric configuration parameter λ set to −0.5 and the allowable margin ε set to 0.1. As evidenced FIGS. 10 and 11 the regression curve 1104 found using the Q-Metric fit the data 1002 far better than the regression curve 1004 found using the prior art Radial Basis Function Kernel.

Support Vector Machine regression using a Q-Metric kernel can be used for a variety of applications including location based services and echo noise cancellation for example. In echo noise cancellation, for each noisy signal vector, there is a desired signal that will be used to cancel the noise. Thus, the noisy signal vector becomes input feature vector, and the desired signal becomes target value for a regression machine.

FIG. 12 is a block diagram of a computer 1200 on which a software implemented Support Vector Machine can be run. The computer 1200 comprises a microprocessor 1202, Random Access Memory (RAM) 1204, Read Only Memory (ROM) 1206, hard disk drive 1208, display adapter 1210, e.g., a video card, a removable computer readable medium reader 1214, a network adaptor 1216, a keyboard 1218, and an I/O port 1220 communicatively coupled through a digital signal bus 1226. A video monitor 1212 is electrically coupled to the display adapter 1210 for receiving a video signal. A pointing device 1222, e.g., a mouse, is coupled to the I/O port 1220 for receiving signals generated by user operation of the pointing device 1222. The network adapter 1216 can be used, to communicatively couple the computer 1200 to an external source of data, e.g., a remote server. The computer readable medium reader 1214 preferably comprises a Compact Disk (CD) drive. A computer readable medium 1224, that includes software embodying the programs described above is provided. The software included on the computer readable medium 1224 is loaded through the removable computer readable medium reader 1214 in order to configure the computer 1200 to carry out programs of the current invention that are described above with reference to the FIGs. The computer 1200 may for example comprise a personal computer or a work station computer. Computer readable media used to store software embodying the programs described above can take on various forms including, but not limited to, magnetic media, optical media, and semiconductor memory.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A pattern recognition system comprising:
a sensor for collecting data from a subject to be identified;
a feature vector extractor coupled to said sensor, said feature vector extractor adapted to receive information from said sensor and produce a feature vector characterizing said subject;
a Q-Metric computer adapted to compute Q-Metric distances between said feature vector characterizing said subject and a plurality of exemplar feature vectors;
a Support Vector Machine coupled to said Q-Metric computer wherein said Support Vector Machine is adapted to assign said feature vector characterizing said subject to a classification based on said Q-Metric distances.

2. The pattern recognition system according to claim 1 wherein said Q-Metric computer and said Support Vector Machine comprise a programmed microprocessor.

3. A regression system comprising:
a plurality of data inputs for inputting an input vector;
a Q-Metric computer adapted to compute Q-Metric distances between said input vector and a plurality of stored support vectors;
a Support Vector Machine coupled to said Q-Metric computer wherein said Support Vector Machine is adapted to compute an output value based on said Q-Metric distances.

4. The regression system according to claim 3 wherein said Q-Metric computer and said Support Vector Machine comprise a programmed microprocessor.

5. A method of training a Support Machine comprising:
reading in a set of training data;
generating an initial population of vectors of numerical parameters, wherein each of the initial population of vectors comprises:
a distance metric configuration parameter;
a plurality of Lagrange multipliers;
a plurality of slack variables;
until a stopping criteria is satisfied, for each of a sequence of generations derived from said initial population of vectors;
evaluating a Support Vector Machine objective function with each vector of numerical parameters in a current generation;
comparing an output of said Support Vector Machine objective function to said stopping criteria;
if said stopping criteria is met outputting a vector of numerical parameters that satisfied said stopping criteria; and
if said stopping criteria is not met:
selecting vectors of numerical parameters to be used in generating a successive generation based on an output of said Support Vector Machine objective function for each vector of numerical parameters;
performing one or more differential evolution operations on said vectors of numerical parameters that have been selected to be used in generating the successive generation.

6. The method according to claim 5 further comprising:
after performing said one or more differential evolution operations: resetting values of numerical parameters that do not satisfy predetermined constraints so that said numerical parameters do satisfy said predetermined constraints.

7. The method according to claim 5 wherein said distance metric configuration parameter comprises a Q-Metric configuration parameter and evaluating said Support Vector Machine objective function comprises evaluating a Q-Metric distance.

8. A computer readable medium storing programming instructions for training a Support Vector Machine, including programming instructions for:
reading in a set of training data;
generating an initial population of vectors of numerical parameters, wherein each of the initial population of vectors comprises:
a distance configuration parameter;
a plurality of Lagrange multipliers;
a plurality of slack variables;
until a stopping criteria is satisfied, for each of a sequence of generations derived from said initial population of vectors;
evaluating a Support Vector Machine objective function with each vector of numerical parameters in a current generation;
comparing an output of said Support Vector Machine objective function to said stopping criteria;
if said stopping criteria is met outputting a vector of numerical parameters that satisfied said stopping criteria; and
if said stopping criteria is not met:
selecting vectors of numerical parameters to be used in generating a successive generation based on an output of said Support Vector Machine objective function for each vector of numerical parameters;
performing one or more differential evolution operations on said vectors of numerical parameters that have been selected to be used in generating the successive generation.

9. The computer readable medium according to claim 8 further storing programming instructions for:
after performing said one or more differential evolution operations: resetting values of numerical parameters that do not satisfy predetermined constraints so that said numerical parameters do satisfy said predetermined constraints.
